(19) United States
(12) Patent Application Publication
(10) Pub. No.: US 2018/0337925 A1
(43) Pub. Date: Nov. 22, 2018

(54) SYSTEM FOR ALLOWING SECURE ACCESS AND USE OF A VIRTUAL CREDENTIAL

(71) Applicant: BANK OF AMERICA CORPORATION, Charlotte, NC (US)

(72) Inventors: Matthew Joseph Wallace, Media, PA (US); Kerry Michelle Cantley, Fort Mill, SC (US); Greg M. Correro, Oak Point, TX (US); Jeantou Alphonse DeGrammont, Decatur, GA (US); Michael Lee Funk, Hockessin, DE (US); Glenn Edward Hupfer, Highland Village, TX (US); Murali Sampath, Flower Mound, TX (US); Donna Lynne Shannon, Mesa, AZ (US)

(21) Appl. No.: 15/597,782

(22) Filed: May 17, 2017

(51) Int. Cl. H04L 29/06; H04L 9/32

(52) U.S. Cl. CPC H04L 63/10; H04L 9/3297; H04L 63/108; H04L 63/0853; H04L 63/107; H04L 63/0807

(57) ABSTRACT

Embodiments of the present invention provide a system for authorizing one or more actions using a random token. The system is typically configured for identifying initiation of a first action by a user via a user application located on a mobile device of the user, recording a time stamp and one or more parameters associated with the mobile device, generating a first random token and associating the generated first random token with the first action, transferring the first random token and associating the generated first random token with a virtual credential, receiving a request from an entity system to authorize the use of the first random token for completing the first action, and authorizing the use of the first random token with the virtual credential for completing the first action.

### FIELD

The present invention relates to authorizing one or more actions by utilizing a random token, thereby allowing secure access to resources associated with the user.

### BACKGROUND

Authenticating a user and authorizing one or more actions performed by the user is increasingly difficult, especially in view of the fact that interactions between users and/or entities are more frequently occurring apart from one another over the Internet and less frequently face-to-face. Moreover, due to the increase in the frequency of electronic interactions between users and/or entities all types of interactions (e.g., over the Internet and/or face-to-face) are subject to potential security issues. As such, improved authentication and authorization systems are needed to provide more accurate authentication of users and authorization of one or more actions performed by the user.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Generally, systems, computer products, and methods are described herein for improved authorization of one or more actions by utilizing a random token. The system generally comprises a memory device with computer-readable program code stored thereon, a communication device, a processing device operatively coupled to the memory device and the communication device, wherein the processing device is configured to execute the computer-readable program code to identify initiation of a first action by a user via a user application, wherein the user application is located on a mobile device of the user, record a time stamp and one or more parameters associated with the mobile device in response to identifying the initiation of the first action, generate a first random token and associate the generated first random token with the first action, transfer the first random token to the user application on the mobile device of the user and associate the first random token with a virtual credential in the user application; receive a request from an entity system to authorize the use of the first random token for completing the first action, wherein the request comprises a set of information, and authorize the use of the first random token with the virtual credential for completing the first action based on determining that the one or more parameters match the set of information received from the entity system and determining that the a current time stamp has not exceeded a predetermined time limit, wherein the predetermined time limit is set based on the recorded time stamp.

In some embodiments, the use of the first random token with the virtual credential for completing the first action is denied based on determining that the one or more parameters do not match the set of information received from the entity and determining that the current time stamp for completing the first action using the first random token has not exceeded the predetermined time limit.

In some embodiments, the processing device is further configured to send a denial notification to the entity system, wherein the denial notification comprises instructions for the entity system not to finalize the first action.

In some embodiments, the processing device is further configured to generate a second random token for completing the first action based on denying the use of the first random token with the virtual credential for completing the first action.

In some embodiments, the processing device is further configured to notify the user about the second random token.

In some embodiments, the processing device is further configured to send an authorization notification to the entity system, wherein the authorization notification comprises authorization for using the first random token with the virtual credential for completing the first action, wherein the entity system upon receiving the notification finalizes the first action.

In some embodiments, the processing device is further configured to identify initiation of a second action by the user via the user application and generate a new random token, wherein the new random token does not match the first random token.

In some embodiments, the one or more parameters include at least a GPS location of the mobile device.

### BRIEF DESCRIPTION OF THE DRAWINGS

Having thus described embodiments of the invention in general terms, reference will now be made to the accompanying drawings, and wherein:

FIG. 1 illustrates a block diagram of an authorization system environment, in accordance with embodiments of the invention.

FIG. 2, presents a block diagram illustrating a mobile device of a user illustrated in FIG. 1, in accordance with embodiments of the present invention;

FIG. 3 presents a block diagram illustrating a computing device of a user illustrated in FIG. 1, in accordance with embodiments of the present invention;

FIG. 4 presents a block diagram illustrating the entity system(s) of FIG. 1, in accordance with embodiments of the present invention;

FIG. 5 presents a block diagram illustrating the authorization system of FIG. 1, in accordance with embodiments of the present invention;

FIG. 6 presents a process flow for allowing secure access and use of a virtual credential, in accordance with embodiments of the present invention;

FIG. 7 presents a process flow for validating a virtual credential to complete a first action, in accordance with embodiments of the present invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

In accordance with embodiments of the invention, the terms “entity” and “third party system” may include any organization that processes financial transactions including, but not limited to, banks, credit unions, savings and loan associations, investment companies, stock brokerages, asset management firms, insurance companies and the like. In accordance with embodiments of the invention, the terms “third party system” and “other third party systems” may include any organizations including, but not limited to, photo identification issuing agencies, network managing organizations, email managing organizations, and/or the like. Furthermore, embodiments of the present invention use the term “user” or “customer.” It will be appreciated by someone with ordinary skill in the art that the user or customer may be a customer of the financial institution or a potential customer of the financial institution or an employee of the financial institution.

In accordance with embodiments of the invention, an “account” is the relationship that a customer has with an entity, such as a financial institution. Examples of accounts include a deposit account, such as a transactional account (e.g., a banking account), a savings account, an investment account, a money market account, a time deposit, a demand deposit, a pre-paid account, a credit account, a debit/deposit account, a non-monetary user profile that includes information associated with the user, or the like. The account is associated with and/or maintained by the entity.

In accordance with embodiments of the invention, an “action” may be a transaction, transfer of funds, transfer of resources, and may refer to any activities or communication between a user and an entity, between an entity and a third party system, activities or communication between multiple entities, communication between technology application and the like. Transfer of resources may refer to a payment, processing of funds, international transfer of funds, purchase of goods or services, a return of goods or services, a payment transaction, a credit transaction, or other interactions involving user's resource or account. Unless specifically limited by the context, a “transaction”, a “transfer of funds”, a “record” may refer to any activity initiated between a user and a resource entity or a third party system, or any combination thereof. Typical financial transactions include point of sale (POS) transactions, automated teller machine (ATM) transactions, person to person (p2p) transfers, internet transactions, online shopping, electronic funds transfers between accounts, transactions with a financial institution teller, personal electronic checks, conducting purchases using loyalty/reward points etc. When discussing the resource transfers or transactions are evaluated it could mean that the transactions has already occurred, is in the process of occurring or being processed, or it has yet to be processed/posted by one or more financial institutions. In accordance with embodiments of the invention, a “token” may be a Card Verification Value (CVV) code associated with a virtual card, wherein the virtual card may be a credit card, a debit card, and/or the like.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more resources or portions of a resource. Furthermore, as used herein, the term “user computing device” or “mobile device” may refer to mobile phones, personal computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

Systems, methods, and computer program products are herein disclosed that provide for improving confidence in the authentication of a user and authorizing one or more transactions performed by the user. With the increase in the number of unauthorized transactions and number of potential security threats for the loss of information, there is a need for an improved authentication and authorization system. The present invention, solves the above problem by providing a unique way for authorizing the transactions using a random token. The system may provide an additional layer of security to a tokenless virtual card stored in a user application on the mobile device. The system may generate tokens on the fly and may later validate those tokens based on one or more parameters such as a GPS location. The system may restrict the use of the token to a transaction at a particular merchant, at a particular location, and for predetermined amount of time. If the user utilizes the token generated for merchant A at a merchant B at location A, the system denies the authorization for such a transaction, thereby avoiding the misappropriation of the virtual card details. The present invention also provides a solution to the problem of losing the virtual card information. Dynamic generation of token and associating the token with the virtual card dynamically will make the stolen information useless.

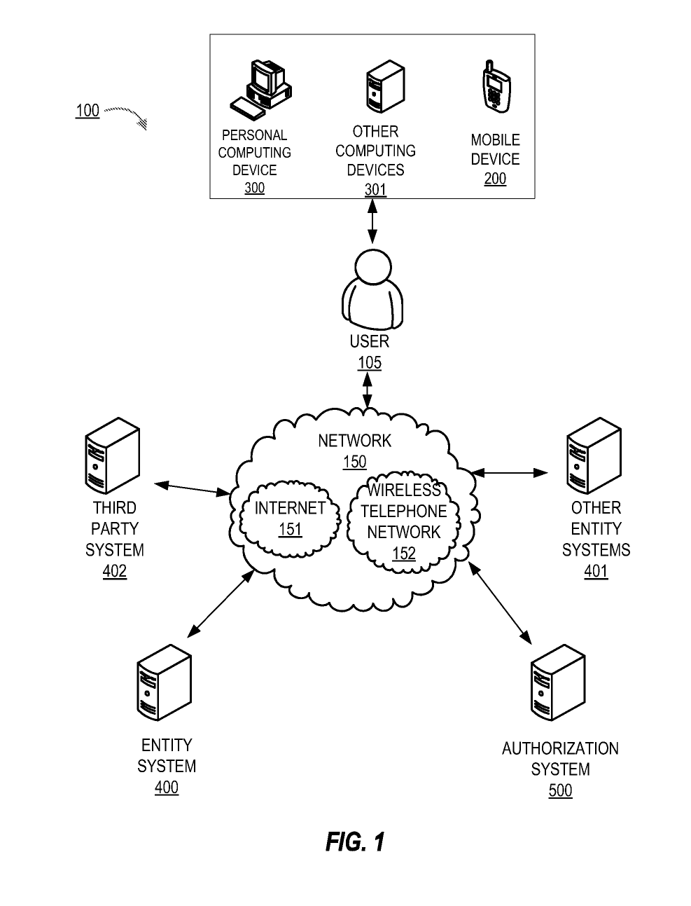

FIG. 1 provides a block diagram illustrating an environment 100 for an authorization system. As depicted in the embodiment of FIG. 1, the operating environment 100 may include an authorization system 500 interacting with an entity system 400, a user 105, a third party system 402, and other entity systems 401, using a network 150. In some embodiments, the authorization system 500 may be maintained by the entity. In some embodiments, the authorization system 500 may be owned by the entity and maintained by a third party. In some embodiments, the authorization system 500 may be a part of the entity system 400. In some embodiments, the user 105 may be a customer of the entity. In some embodiments, the system environment may include other third party systems and other entity systems. In some embodiments, the authorization system 500 may interact with a devices associated with a plurality of users associated with the entity or a third party simultaneously. In some embodiments, the operating environment may include a point of sale (POS) or a point of transaction (POT) device (not shown). In some embodiments, the operating environment may include an Automated Teller Machine (ATM) (not shown).

The environment 100 also may include a plurality of user devices. The user devices may include any machine, apparatus, system or the like that may be connected to and communicate with other devices over a network 150. At least one of the devices may include a personal computing device 300, other computing devices 301, and a mobile device 200 for use by the user 105. The other computing devices 301 may be any device that employs a processor and memory and can perform computing functions, such as a personal computing device 300 or a mobile device 200, that may be connected to or access the network 150. The personal computing device 300 may include a personal computer such as a desktop computer, laptop computer, tablet or any type of personal computing device that may be connected to a network by landline or wireless access such as wireless local area network (WLAN) such as Wi-Fi based on the Institute of Electrical and Electronics Engineers' (IEEE) 802.11 standards, Bluetooth short-wavelength UHF radio waves in the ISM band from 2.4 to 2.485 GHz or other wireless access technology. As used herein, the mobile device 200 may include any mobile communication device, such as a cellular telecommunications device (i.e., a cell phone or mobile phone), personal digital assistant (PDA), a mobile Internet accessing device, tablet computer, or other mobile device. A mobile device may connect to the network by a cellular telecommunications network or by Wi-Fi, Bluetooth or other access technology.

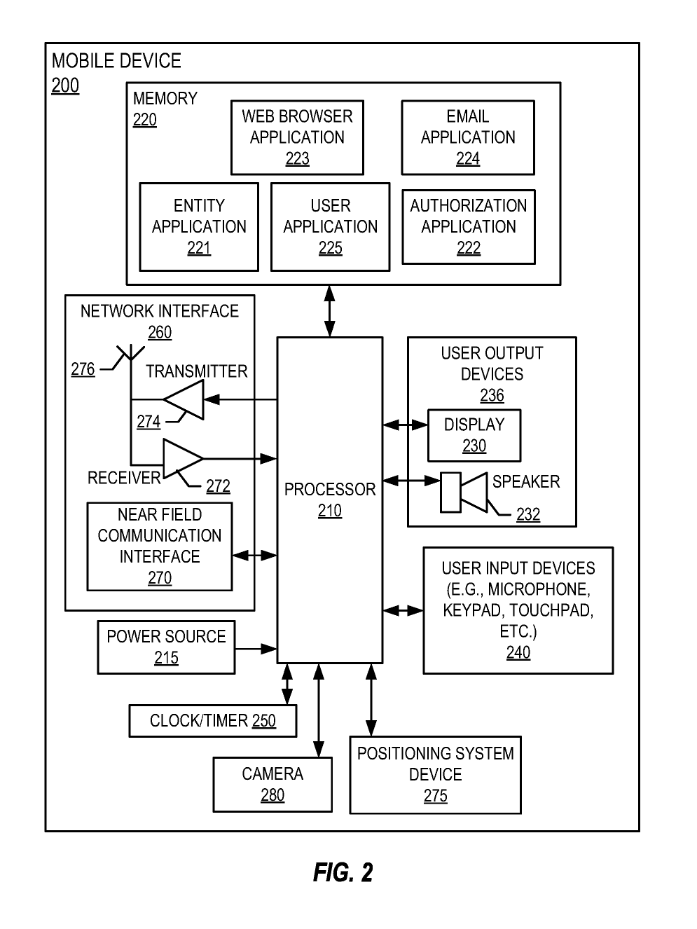

FIG. 2 provides a block diagram illustrating a user's mobile device 200 of FIG. 1 in more detail, in accordance with embodiments of the invention. In one embodiment of the invention, the mobile device 200 is a mobile telephone. However, it should be understood that a mobile telephone and the embodiment of the mobile device 200 shown in FIG. 2 are merely illustrative of one type of mobile device 200 that may benefit from, employ, or otherwise be involved with embodiments of the present invention and, therefore, should not be taken to limit the scope of embodiments of the present invention. Other types of mobile devices 200 may include portable digital assistants (PDAs), pagers, tablets, mobile televisions, gaming devices, laptop computers, cameras, video recorders, audio/video player, radio, Global Positioning Systems (GPS) devices, or any combination of the aforementioned.

Some embodiments of the mobile device 200 include a processor 210 communicably coupled to such devices as a memory 220, user output devices 236, user input devices 240, and a network interface 260. The mobile device 200 further includes a power source 215, such as a battery, for powering various circuits and other devices that are used to operate the mobile device 200. Embodiments of the mobile device 200 may also include a clock or other timer 250 configured to determine and, in some cases, communicate actual or relative time to the processor 210 or one or more other devices. The processor 210, and other processing devices described herein, generally include circuitry for implementing communication and/or logic functions of the associated device. For example, the processor 210 may include a digital signal processor device, a microprocessor device, and various analog to digital converters, digital to analog converters, and/or other support circuits. Control and signal processing functions of the mobile device 200 are allocated between these devices according to their respective capabilities. The processor 210 thus may also include the functionality to encode and interleave messages and data prior to modulation and transmission. The processor 210 can additionally include an internal data modem. Further, the processor 210 may include functionality to operate one or more software programs, which may be stored in the memory 220. For example, the processor 210 may be capable of operating a connectivity program, such as a web browser application 223. The web browser application 223 may then allow the mobile device 200 to transmit and receive web content, such as, for example, location-based content and/or other web page content, according to a Wireless Application Protocol (WAP), Hypertext Transfer Protocol (HTTP), and/or the like. The memory device 220 may include other applications such as entity application 221, e-mail application 224, user application 225, authorization application 222, and/or the like. The user application 225 may be a digital wallet application or any application that maintains virtual cards which is provided by the entity system 400. In some embodiments, the authorization application 222 may be a part of the user application 225. In some embodiments, the authorization application 222 allows the mobile device 200 to interact with the authorization system 500. In some embodiments, the entity application 221 allows the mobile device 200 to interact with the entity system 400. In one embodiment, the entity application 221 may be an online banking application. In some embodiments, the entity application 221, the user application 225, and authorization application 222 may be part of one master application provided and maintained by the entity system 400.

The processor 210 is configured to use the network interface 260 to communicate with one or more other devices on the network 150. In this regard, the network interface 260 includes an antenna 276 operatively coupled to a transmitter 274 and a receiver 272 (together a “transceiver”). The processor 210 is configured to provide signals to and receive signals from the transmitter 274 and receiver 272, respectively. The signals may include signaling information in accordance with the air interface standard of the applicable cellular system of the wireless telephone network 152. In this regard, the mobile device 200 may be configured to operate with one or more air interface standards, communication protocols, modulation types, and access types. By way of illustration, the mobile device 200 may be configured to operate in accordance with any of a number of first, second, third, and/or fourth-generation communication protocols and/or the like. For example, the mobile device 200 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Consolidated Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 3GPP protocols and/or the like. The mobile device 200 may also be configured to operate in accordance with non-cellular communication mechanisms, such as via a wireless local area network (WLAN) or other communication/data networks.

The network interface 260 may also include a near field communication (NFC) interface 270. As used herein, the phrase “NFC interface” generally refers to hardware and/or software that is configured to contactlessly and/or wirelessly send and/or receive information over relatively short ranges (e.g., within four inches, within three feet, within fifteen feet, and the like). The NFC interface 270 may include a smart card, key card, proximity card, Bluetooth® device, radio frequency identification (RFID) tag and/or reader, transmitter, receiver, and/or the like. In some embodiments, the NFC interface 270 communicates information via radio, infrared (IR), and/or optical transmissions. In some embodiments, the NFC interface 270 is configured to operate as an NFC transmitter and/or as an NFC receiver (e.g., an NFC reader). Also, it will be understood that the NFC interface 270 may be embedded, built, carried, and/or otherwise supported in and/or on the mobile device 200. In some embodiments, the NFC interface 270 is not supported in and/or on the mobile device 200, but the NFC interface 270 is otherwise operatively connected to the mobile device 200 (e.g., where the NFC interface 270 is a peripheral device plugged into the mobile device 200). Other apparatuses having NFC interfaces mentioned herein may be configured similarly. In some embodiments, the NFC interface 270 of the mobile device 200 is configured to contactlessly and/or wirelessly communicate information to and/or from a corresponding NFC interface of another apparatus (e.g., a point of sale (POS) device, an automated teller machine (ATM) or another mobile or computing device). In one embodiment of the present invention, the NFC interface of the mobile device 200 wirelessly communicates information (virtual card information such as virtual card number, CVV code, expiration date) stored in the user application 225 to and/or from a corresponding NFC interface of a POS device to perform a transaction.

As described above, the mobile device 200 has a user interface that may be made up of user output devices 236 and/or user input devices 240. The user output devices 236 include a display 230 (e.g., a liquid crystal display or the like) and a speaker 232 or other audio device, which are operatively coupled to the processor 210. The user input devices 240, which allow the mobile device 200 to transmit data, may include any of a number of devices allowing the mobile device 200 to transmit data, such as a keypad, keyboard, touch-screen, touchpad, microphone, mouse, joystick, other pointer device, button, soft key, and/or other input device(s). The user interface may also include a camera 280, such as a digital camera.

The mobile device 200 may also include a positioning system device 275 that is configured to be used by a positioning system to determine a location of the mobile device 200. For example, the positioning system device 275 may include a GPS transceiver. In some embodiments, the positioning system device 275 is at least partially made up of the antenna 276, transmitter 274, and receiver 272 described above. For example, in one embodiment, triangulation of cellular signals may be used to identify the approximate location of the mobile device 200. In other embodiments, the positioning system device 275 includes a proximity sensor or transmitter, such as an RFID tag, that can sense or be sensed by devices known to be located proximate a location to determine that the mobile device 200 is located proximate these known devices.

The memory 220 is operatively coupled to the processor 210. As used herein, “memory” or “memory device” includes any computer readable medium (as defined herein below) configured to store data, code, or other information. The memory 220 may include volatile memory, such as volatile Random Access Memory (RAM) including a cache area for the temporary storage of data. The memory 220 may also include non-volatile memory, which can be embedded and/or may be removable. The non-volatile memory can additionally or alternatively include an electrically erasable programmable read-only memory (EEPROM), flash memory or the like.

The memory 220 can store any of a number of applications which include computer-executable instructions/code executed by the processor 210 to implement the functions of the mobile device 200 and/or one or more of the process/method steps described herein. The memory 220 includes an entity application 221 that may be used to allow communication with an entity system such as the entity system 400 and/or the smart devices to implement the system of the invention. The use of the entity application 221 may facilitate access to the system of the invention by providing log-in systems including user authentication systems, account information, system controls or the like.

These applications also typically provide a graphical user interface (GUI) on the display 230 that allows the plurality of users 110 to communicate with the mobile device 200, the entity system 400 and/or other devices or systems. The memory 220 can also store any of a number of pieces of information, and data, used by the mobile device 200 and the applications and devices that make up the mobile device 200 or are in communication with the mobile device 200 to implement the functions of the mobile device 200 and/or the other systems described herein. For example, the memory 220 may include such data as user authentication information. In embodiments of the present invention, a resource allocation interface is presented on the display 230 to receive input from the user.

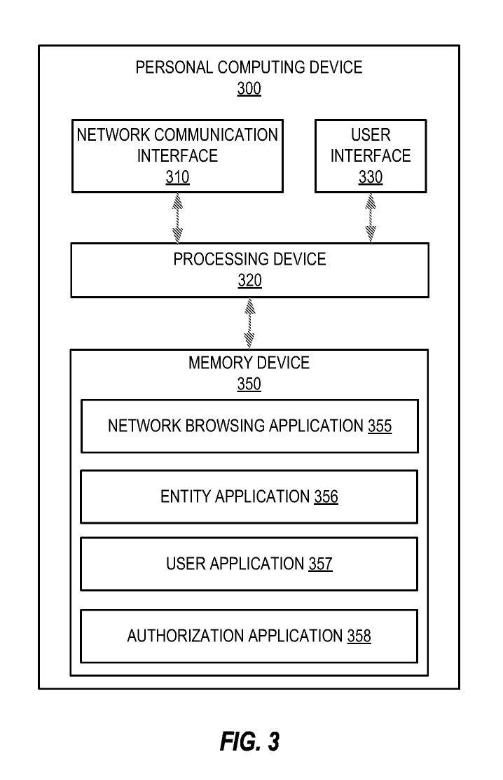

Referring now to FIG. 3, the personal computing device 300 also includes various features, such as a network communication interface 310, a processing device 320, a user interface 330, and a memory device 350. The network communication interface 310 includes a device that allows the personal computing device 300 to communicate over the network 150 (shown in FIG. 1). In one embodiment of the invention, a network browsing application 355 provides for a user to establish network communication with an entity system 400 and authorization system 500.

As used herein, a “processor” or “processing device,” such as the processing device 320, generally refers to a device or combination of devices having circuitry used for implementing the communication and/or logic functions of a particular system. For example, a processing device 320 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 320 may further include functionality to operate one or more software programs based on computer-executable program code thereof, which may be stored in memory device 350. As the phrase is used herein, a processor or processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” generally includes a plurality of interface devices and/or software that allow a customer to input commands and data to direct the processing device to execute instructions. For example, the user interface 330 presented in FIG. 3 may include a graphical user interface (GUI) or an interface to input computer-executable instructions that direct the processing device 320 to carry out specific functions. The user interface 330 employs certain input and output devices as previously described with reference to FIGS. 1 and 2. These input and output devices may include a display, mouse, keyboard, button, touchpad, touch screen, microphone, speaker, LED, light, joystick, switch, buzzer, bell, and/or other user input/output device for communicating with one or more users. In embodiments of the present invention, the resource allocation interface is presented on the display of the personal computing device 300 to receive input form the user.

As used herein, a “memory” or “memory device” generally refers to a device or combination of devices that store one or more forms of computer-readable media for storing data and/or computer-executable program code/instructions. Computer-readable media is defined in greater detail below. For example, in one embodiment, the memory device 350 includes any computer memory that provides an actual or virtual space to temporarily or permanently store data and/or commands provided to the processing device 320 when it carries out its functions described herein. The memory device 350 may include such applications as a conventional network browsing application 355, an entity application 356, a authorization application 358 and/or the like. The entity application 356 may be used to allow communication with an entity system, such as the entity system 400. The authorization application 358 may be used to allow communication with the authorization system 500 and the entity system 400 to implement one or more actions. The memory device 350 may further include a user application 357 which may be any application that maintains virtual cards on the computing device 300. In some embodiments, the user application may be a part of the authorization application 358 or the entity application 356. The other computing devices 301 as shown in FIG. 1 may include similar system blocks as the personal computing device 300.

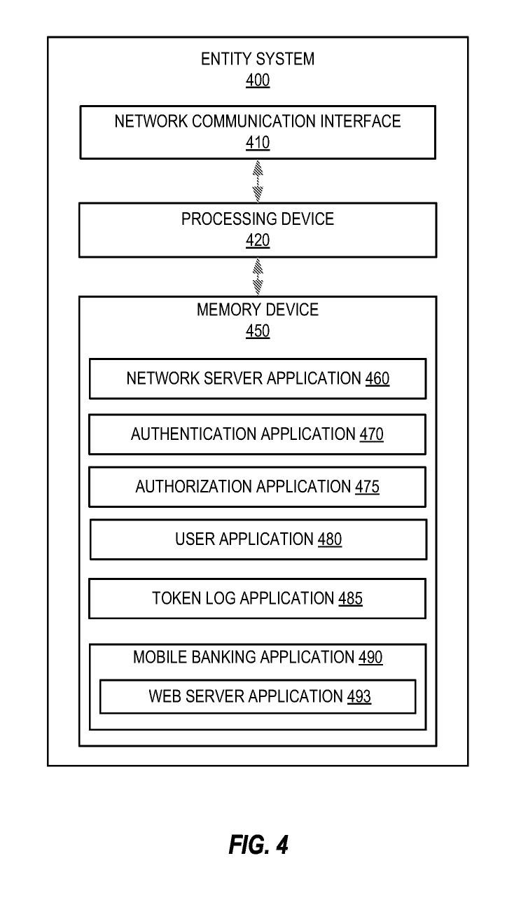

FIG. 4 provides a block diagram illustrating the entity system 400, in greater detail, in accordance with embodiments of the invention. As illustrated in FIG. 4, in one embodiment of the invention, the entity system 400 includes one or more processing devices 420 operatively coupled to a network communication interface 410 and a memory device 450. In certain embodiments, the entity system 400 is operated by an entity, such as a financial institution.

It should be understood that the memory device 450 may include one or more databases or other data structures/repositories. The memory device 450 also includes computer-executable program code that instructs the processing device 420 to operate the network communication interface 410 to perform certain communication functions of the entity system 400 described herein. For example, in one embodiment of the entity system 400, the memory device 450 includes, but is not limited to, a network server application 460, an authentication application 470, authorization application 475, a user application 480, a token log application 485, and a mobile banking application 490 including a mobile web server application 493, and other computer-executable instructions or other data. The computer-executable program code of the network server application 460, the authentication application 470, or the mobile banking application 490 may instruct the processing device 420 to perform certain logic, data-processing, and data-storing functions of the entity system 400 described herein, as well as communication functions of the entity system 400. The mobile banking application 490 communicates with the user devices to facilitate communication between the user and the entity. The memory device 450 may include merchant identifying information and/or the like.

In one embodiment, the network server application 460, the authentication application 470, and the mobile banking application 490 are configured to invoke or use the authentication application 470 and authorization application 475 when authenticating a user to the entity system 400. In such an embodiment, where a token generated by the authorization system 500 is used to authenticate the user, the entity system may communicate with the authorization system 500 via the authorization application 475 to verify the token. In some embodiments, the authorization application 475 allows communication with the authorization system 500 using the network communication interface 410. In one embodiment, the token log application 485 manages a set of records associated with tokens generated by the authorization application. The set of records may include the one or more parameters which document the usage of the token.

As used herein, a “communication interface” generally includes a modem, server, transceiver, and/or other device for communicating with other devices on a network. The network communication interface 410 is a communication interface having one or more communication devices configured to communicate with one or more other devices on the network 150, such as the mobile device 200, the personal computing device 300, and/or other computing devices 301. The processing device 420 is configured to use the network communication interface 410 to transmit and/or receive data and/or commands to and/or from the other devices connected to the network 150.

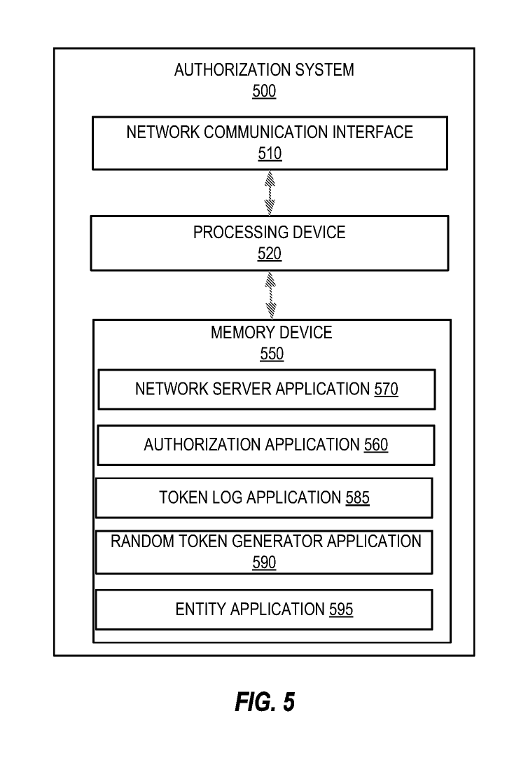

FIG. 5 presents a block diagram illustrating the authorization system 500, in accordance with embodiments of the invention. As illustrated in FIG. 4, in one embodiment of the invention, the authorization system 500 includes one or more processing devices 520 operatively coupled to a network communication interface 510 and a memory device 550. In certain embodiments, the authorization system 500 is operated by an entity, such as a financial institution.

It should be understood that the memory device 550 may include one or more databases or other data structures/repositories. The memory device 550 also includes computer-executable program code that instructs the processing device 520 to operate the network communication interface 510 to perform certain communication functions of the authorization system 500 described herein. For example, in one embodiment of the authorization system 500, the memory device 550 includes, but is not limited to, a network server application 570, an authorization application 560, and a token log application 585, a random token generator application 590, an entity application 595, and other computer-executable instructions or other data. The computer-executable program code of the network server application 570, the authorization application 560, and the token log application 585, the random token generator application 590, the entity application 595 may instruct the processing device 520 to perform certain logic, data-processing, and data-storing functions of the authorization system 500 described herein, as well as communication functions of the authorization system 500. The entity application 595 communicates with the user devices to facilitate communication between the user and the entity. The token log application 585 creates records associated with the usage of token. The authorization application 560 communicates with the entity application 221, user application 225, or the authorization application 222 in the mobile device 200 to facilitate one or more steps in the process flows 600 and 700. The random token generator application 590 generates random tokens and transfers the random tokens to user application 225 or authorization application 222 in the mobile device of the user via the network communication interface 510.

As used herein, a “communication interface” generally includes a modem, server, transceiver, and/or other device for communicating with other devices on a network. The network communication interface 510 is a communication interface having one or more communication devices configured to communicate with one or more other devices on the network 150, such as the mobile device 200, the personal computing device 300, and/or other computing devices 301. The processing device 520 is configured to use the network communication interface 510 to transmit and/or receive data and/or commands to and/or from the other devices connected to the network 150.

Furthermore, as used herein, a “memory device” generally refers to a device or combination of devices that store one or more forms of computer-readable media and/or computer-executable program code/instructions. Computer-readable media is defined in greater detail below. For example, in one embodiment, the memory device 550 includes any computer memory that provides an actual or virtual space to temporarily or permanently store data and/or commands provided to the processing device 520 when it carries out its functions described herein.

In some embodiments, token log data, user profiles and the like may be stored in a non-volatile memory distinct from instructions for executing one or more process steps discussed herein that may be stored in a volatile memory such as a memory directly connected or directly in communication with a processing device executing the instructions. In this regard, some or all the process steps carried out by the processing device may be executed in near-real-time, thereby increasing the efficiency by which the processing device may execute the instructions as compared to a situation where one or more of the instructions are stored and executed from a non-volatile memory, which may require greater access time than a directly connected volatile memory source. In some embodiments, one or more of the instructions are stored in a non-volatile memory and are accessed and temporarily stored (i.e., buffered) in a volatile memory directly connected with the processing device where they are executed by the processing device. Thus, in various embodiments discussed herein, the memory or memory device of a system or device may refer to one or more non-volatile memory devices and/or one or more volatile memory devices.

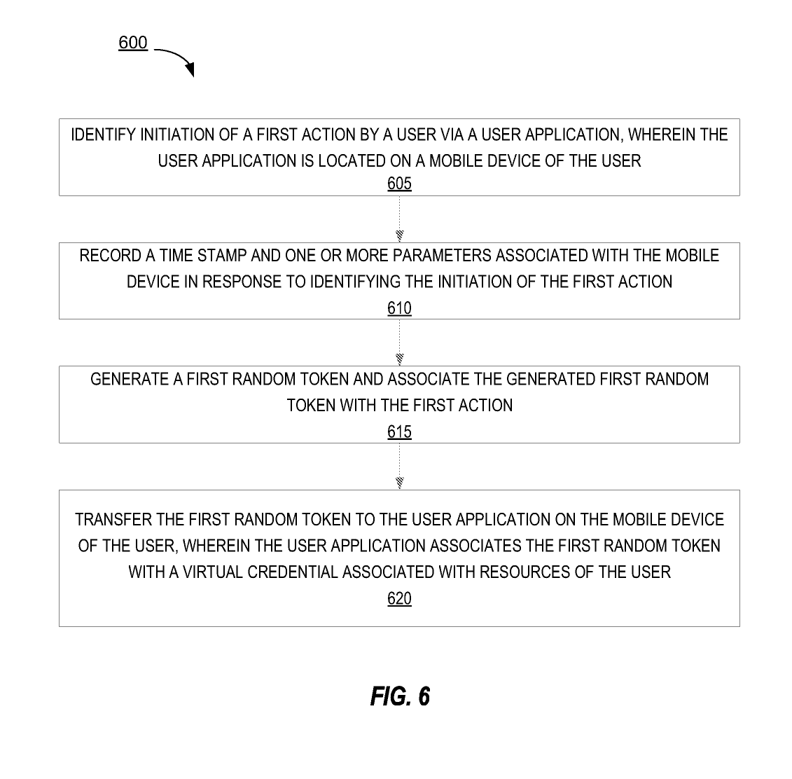

FIG. 6 illustrates a high level process flow 600 for allowing secure access and use of a virtual credential. The process flow 600 is presented in reference to the mobile device 200. The same process flow applies to any of the user devices (including personal computing device 300 and other computing devices 301). As shown in block 605, the system identifies initiation of a first action by a user via a user application, wherein the user application is located on the mobile device of the user. The first action may be a payment transaction for purchase of products or services, and/or the like. The user application may be any application that maintains virtual cards on the mobile device of the user. In some embodiments, the virtual card may be a credit card or a debit card, and/or the like. The virtual card may be associated with any accounts of the user, wherein the account may be a checking account, a savings account, and/or the like. In some embodiments, the user application may be a digital wallet. In some other embodiments, the user application may be an application provided by the entity system to maintain the virtual cards associated with the entity system. In some embodiments, the system identifies the initiation of a first action based on identifying that the user has accessed the user application 225. For example, when the user accesses a virtual card stored in a digital wallet application before performing a transaction, the system identifies initiation of a transaction. In one embodiment, the authorization application 222 may monitor the user application 225 to identify initiation of actions. In some embodiments, the user may notify the system regarding the initiation of a first action. In some embodiments, the user may notify the authorization system 500 via the authorization application 222 that the user is about to perform an action and the notification may further comprise a request for a random token to associated with a virtual card stored in the user application 225. For example, the user may notify the authorization system 500 that he is about to perform a transaction using a virtual credit card and may request the authorization system to send a Card Verification Value (CVV) code associated with the virtual credit card stored in the user application 225. In addition to notifying the authorization system 500, the user may communicate information associated with the transaction such as a merchant name, or the like. The user application 225 may contain one or more tokenless virtual cards. For example, the virtual card may be a virtual credit card without a CVV code.

As shown in block 610, the system records a time stamp and one or more parameters associated with the mobile device in response to identifying the initiation of the first action. The system stores the records associated with the use of token in the memory device 550. The one or more parameters may include at least a GPS location of the mobile device 200 associated with the initiation of the first action, type of the first action, and/or the like. The system may identify the type of first action based on the GPS location. For example, the GPS location associated with the initiation of the first action may be a merchant store location. The system may automatically identify the merchant name associated with the GPS location. In some embodiments, the system may prompt the user to enter the merchant name associated with the first action. In some embodiments, wherein the first action is initiated on the computing device 300, the system identifies the location of the computing device using the Internet Protocol (IP) address. For example, the token log application 585 may create a record comprising time stamp associated with the initiation of the transaction, GPS location of the mobile device 200 associated with the initiation of the transaction, and/or the like. In some embodiments, wherein the user notifies the system about the initiation of the first action, the system identifies the time stamp associated with the notification and the GPS location of the device which notified the system about the initiation of the first action.

As shown in block 615, the system generates a first random token and associates the generated first random token with the first action. The first random token may be a Card Verification Value (CVV) code. In some embodiments, the CVV code may be a three digit code. In alternate embodiments, the CVV code may be a four digit code. In some embodiments, the CVV code may code greater than four digit code. The CVV code is a single-use code. The system may use a random generator algorithm to generate the first random token. In one embodiment of the present invention, after generating the first random token, the system may update the record created by the token log application 585 with the generated CVV code. In other words, the system associates the generated CVV code with the one or more parameters associated with the first action. For example, the system associates the generated CVV code with the GPS location, merchant name, and/or the like, thereby limiting the use of the generated CVV code to identified GPS location and the merchant.

As shown in block 620, the system transfers the first random token to the user application 225 on the mobile device 200 of the user, wherein the user application associates the first random token with a virtual credential associated with resources of the user. In some embodiments, the system transfers the first random token to the authorization application 222 on the mobile device 200 of the user and upon receiving the first random token, the authorization application 222 associates the first random token with a virtual card stored in the user application 225. For example, the authorization application associates the CVV code with the virtual card stored in the user application, thereby preparing the virtual card for processing the transaction.

In some embodiments, the first action may be an online transaction performed using the web browser application 223. In such an embodiment, the user may enter the CVV code associated with the virtual card into the web browser application 223. Once the user submits the virtual card information and CVV code to a merchant or a third party system 402 via the web browser application 223, the system may update the record created by the token log application. In alternate embodiments, the first action may be a payment transaction at a point of sale (POS) device. In such an embodiment, the authorization application may cause the mobile device 200 to transfer the virtual card information including the CVV code stored in the user application, to the point of sale device using Near Field Communication (NFC) interface 270. In some embodiments, the authorization application may cause the mobile device 200 to transfer the virtual card information excluding the CVV code to the point of sale device using Near Field Communication interface 270. In such an embodiment, the point of sale device may prompt the user to input the first random token using any of the available input devices in the point of sale device. The point of sale device may be maintained by the entity system 400 or by a third party system 402. Upon receiving the virtual card information and CVV code, the merchant or the third party system may transfer the information to the entity system 400, wherein the user is a customer of the entity system. For example, the acquiring financial institution associated with the merchant may transfer the information associated with the virtual card to the issuing financial institution holding the resources of the user. The issuing financial institution maintains the accounts of the user associated with the virtual card. The acquiring financial institution maintains the account of the merchant. Upon receiving the information associated with the virtual card, the entity system 400 may send a request to the authorization system 500 to verify the information associated with the virtual card. The verification of information associated with the virtual card is explained in detail below.

In exemplary embodiment of the present invention, the first action may be a transaction at an Automated Teller Machine and after or before initiating the transaction at the Automated Teller Machine, the user may request the system to generate the first random token. The system may follow the process described in block 610-620. After receiving the first random token, the user may input the first random token into the Automated Teller Machine using any of the available input methods (keypad, audio, video, and/the like). The Automated Teller Machine may be maintained by the entity system 400. Upon receiving the first random token as an input form the user, the entity system associated with the Automated Teller Machine may send a request to the authorization system 500 to verify the information associated with the virtual card. The verification of information associated with the virtual card is explained in detail below.

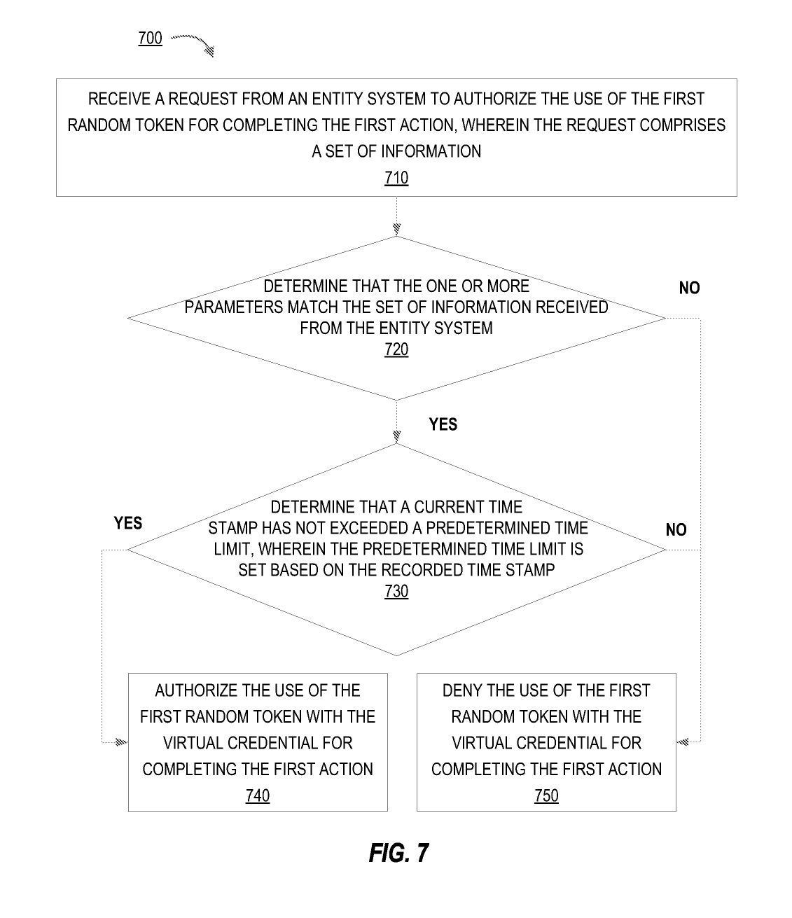

FIG. 7 illustrates a process flow 700 for validating the virtual credential to complete the first action. As shown in block 710, the system receives a request from the entity system 400 to authorize the use of the first random token for completing the first action, wherein the request comprises a set of information. Once the user submits the information associated with the virtual card to the merchant in an online transaction, the merchant or the other entity system 401 maintaining the account of the merchant may transfer the information associated with the virtual card to the entity system 400. In some embodiments, the other entity system 401 may transfer additional information associated with the merchant to the entity system 400. For example, the other entity system 401 may transfer additional information about the merchant such as merchant name, merchant code, merchant location, and/or the like to the entity system. In one embodiment of the present invention, the entity system 400 upon receiving the information from the other entity system 401, sends a request to the authorization system to authorize the use of the first random token associated with the virtual card for completing the first action. In such an embodiment, the entity system may transfer the set of information received from the other entity system 401 comprising the additional information and the information associated with the virtual card to the authorization system 500 along with the request to authorize the use of the first random token.

As shown in 720, upon receiving the request form the entity system 400 to authorize the use of the first random token for completing the first action, the authorization system determines that the one or more parameters match the set of information received from the entity system. For example, the system may compare the one or more parameters stored in the record created by the token log application with the set of information received form the entity system. The system may compare the GPS location and merchant name stored in the record with the set of information comprising GPS location and merchant name. If the one or more parameters match the set of information, the process flow proceeds to block 730. If the one or more parameters do not match the set of information, the process flow proceeds to block 750. In addition, the set of information received from the entity system may comprise the random token sent by the merchant. The system upon receiving the set of information may verify that the random token received from the entity system matches the first random token generated by the system.

Next as shown in block 730, the system determines that a current time stamp has not exceeded a predetermined time limit, wherein the predetermined time limit is set based on the recorded time stamp. In some embodiments, the system defines the predetermined time limit. In alternate embodiments, the entity system defines the predetermined time limit. In some embodiments, the predetermined time limit may be five minutes from the recorded time stamp. For example, the system determines that the current time stamp has not exceeded the five minute time limit. In alternate embodiments, the predetermined time limit may be more or less than five minutes. If the system determines that the current time stamp has not exceeded a predetermined time limit, the process flow proceeds to block 740. If the system determines that the current time stamp has exceeded a predetermined time limit, the process flow proceeds to block 730.

As shown in block 740, the system authorizes the use of the first random token with the virtual credential for completing the first action. For example, the system validates the CVV code and virtual card information based on determining that the GPS location and merchant name match the set of information received from the entity system and that the current time stamp has not exceeded the predetermined time limit, thereby allowing the use of CVV code for a particular transaction and for a particular amount of time. In some embodiments, the system authorizes the use of the first random token and sends an authorization notification to the entity system, wherein the entity system finalizes or completes the first action. For example, the entity system finalizes the transaction by transferring the resources form the account of the user to the other entity system maintaining the account of the merchant. The use of dynamic random token for performing transactions provides an extra layer of security, thereby limiting the security risks (such as loss of virtual card information) and the number of unauthorized transactions. In the case of loss of virtual card information, the lost information may be of no use without the random token.

As shown in block 750, the system denies the use of the first random token with the virtual credential for completing the first action. For example, the system determines that the first transaction was initiated at location A and from the set of information received from the entity system, the system determines that the transaction was performed at location B. The system identifies such mismatch and denies the use of the first random token to complete the first action. In another example, the system determines that the time current time stamp exceeded a predetermined time limit of five minutes from when the token was created and denies the use of first random token to complete the first action. In some embodiments, the system may send a denial notification to the entity system 400, wherein the denial notification comprises instructions for the entity system not to finalize the first action. In such an embodiment, the entity system may notify the merchant and the merchant may not process the first action. In some embodiments, the system may generate a second random token for completing the first action and notify the user about the denial of the transaction and the generated second random token. The user upon receiving this notification may submit the second random token to the merchant via the web browser application.

In one embodiment, the system may identify initiation of a second action by the user via the user application and repeat the process flows 600 and 700. The system may generate a new random token and associate the new random token with the second action, wherein the new random token does not match the first random token. The random token generator application may generate random tokens which do not match the previous random tokens. In some cases, the random token generator application in the system may access the records created by the token log application to determine the types of previously generated tokens and may create a new random token which do not match the previously generated tokens in the record.

In an exemplary embodiment of the present invention, the generated random token may be used as a form of authentication to access resources or an application. In such an embodiment, the user may send a request to the authorization system for a random token and upon receiving the random token the user may enter the generated random token to access an entity application such as an online banking application or an account of the user. The entity system or the entity application may communicate with the authorization system to verify the random token and upon successful verification the entity system may grant access to the account and resources of the user. This form of authentication may be used in combination with other authentication methods discussed in the U.S. patent applications, which are hereby incorporated by reference in its entirety. This form of authentication may be used for authenticating the user at an Automated Teller Machine.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. patent | | |
|---|---|---|---|
| | application | | |
| Docket Number | Ser. No. | Title | Filed On |
| 7777US1.014033.3012 | To be assigned | SYSTEM FOR ELECTRONIC | Concurrently |
| | | AUTHENTICATION WITH | herewith |
| | | LIVE USER | |
| | | DETERMINATION | |
| 7778US1.014033.3008 | To be assigned | SYSTEM FOR ELECTRONIC | Concurrently |
| | | AUTHENTICATION WITH | herewith |
| | | BOT DETECTION AND | |
| | | DENIAL | |
| 7779US1.014033.3013 | To be assigned | SYSTEM FOR | Concurrently |
| | | PROVISIONING AND | herewith |
| | | ALLOWING SECURE | |
| | | ACCESS TO A VIRTUAL | |
| | | CREDENTIAL | |

What is claimed is:

1. A system for authorizing one or more actions using a random token, the system comprising:
a memory device with computer-readable program code stored thereon;
a communication device;
a processing device operatively coupled to the memory device and the communication device, wherein the processing device is configured to execute the computer-readable program code to:
identify initiation of a first action by a user via a user application, wherein the user application is located on a mobile device of the user;
record a time stamp and one or more parameters associated with the mobile device in response to identifying the initiation of the first action;
generate a first random token and associate the generated first random token with the first action;
transfer the first random token to the user application on the mobile device of the user and associate the first random token with a virtual credential in the user application;
receive a request from an entity system to authorize the use of the first random token for completing the first action, wherein the request comprises a set of information; and
authorize the use of the first random token with the virtual credential for completing the first action based on:
determining that the one or more parameters match the set of information received from the entity system; and
determining that the a current time stamp has not exceeded a predetermined time limit, wherein the predetermined time limit is set based on the recorded time stamp.

2. The system of claim 1, wherein the use of the first random token with the virtual credential for completing the first action is denied based on:
determining that the one or more parameters do not match the set of information received from the entity system; and
determining that the current time stamp for completing the first action using the first random token has not exceeded the predetermined time limit.

3. The system of claim 2, wherein the processing device is further configured to send a denial notification to the entity system, wherein the denial notification comprises instructions for the entity system not to finalize the first action.

4. The system of claim 2, wherein the processing device is further configured to generate a second random token for completing the first action based on denying the use of the first random token with the virtual credential for completing the first action.

5. The system of claim 4, wherein the processing device is further configured to notify the user about the second random token.

6. The system of claim 1, wherein the processing device is further configured to send an authorization notification to the entity system, wherein the authorization notification comprises authorization for using the first random token with the virtual credential for completing the first action, wherein the entity system upon receiving the notification finalizes the first action.

7. The system of claim 1, wherein the processing device is further configured to identify initiation of a second action by the user via the user application and generate a new random token, wherein the new random token does not match the first random token.

8. The system of claim 1, wherein the one or more parameters include at least a GPS location of the mobile device.

9. A computer-implemented method for authorizing one or more actions using a random token, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
identifying initiation of a first action by a user via a user application, wherein the user application is located on a mobile device of the user;
recording a time stamp and one or more parameters associated with the mobile device in response to identifying the initiation of the first action;
generating a first random token and associate the generated first random token with the first action;
transferring the first random token to the user application on the mobile device of the user and associate the first random token with a virtual credential in the user application;
receiving a request from an entity system to authorize the use of the first random token for completing the first action, wherein the request comprises a set of information; and
authorizing the use of the first random token with the virtual credential for completing the first action based on:
determining that the one or more parameters match the set of information received from the entity system; and
determining that the a current time stamp has not exceeded a predetermined time limit, wherein the predetermined time limit is set based on the recorded time stamp.

10. The computer-implemented method of claim 9, wherein the use of the first random token with the virtual credential for completing the first action is denied based on:
determining that the one or more parameters do not match the set of information received from the entity system; and
determining that the current time stamp for completing the first action using the first random token has not exceeded the predetermined time limit.

11. The computer-implemented method of claim 10, wherein the method further comprises sending denial notification to the entity system, wherein the denial notification comprises instructions for the entity system not to finalize the first action.

12. The computer-implemented method of claim 10, wherein the method further comprises generating a second random token for completing the first action.

13. The computer-implemented method of claim 12, wherein the method further comprises notifying the user about the second random token.

14. The computer-implemented method of claim 9, wherein the method further comprises sending an authorization notification to the entity system, wherein the authorization notification comprises authorization for using the first random token with the virtual credential for completing the first action, wherein the entity system upon receiving the notification finalizes the first action.

15. A computer program product for authorizing one or more actions using a random token, the computer program product comprising at least one non-transitory computer-readable medium having computer-readable program code portions embodied therein, the computer-readable program code portions comprising:
an executable portion configured to identify initiation of a first action by a user via a user application, wherein the user application is located on a mobile device of the user;
an executable portion configured to record a time stamp and one or more parameters associated with the mobile device in response to identifying the initiation of the first action;
an executable portion configured to generate a first random token and associate the generated first random token with the first action;
an executable portion configured to transfer the first random token to the user application on the mobile device of the user and associate the first random token with a virtual credential in the user application;
an executable portion configured to receive a request from an entity system to authorize the use of the first random token for completing the first action, wherein the request comprises a set of information; and
an executable portion configured to authorize the use of the first random token with the virtual credential for completing the first action based on:
determining that the one or more parameters match the set of information received from the entity system; and
determining that the a current time stamp has not exceeded a predetermined time limit, wherein the predetermined time limit is set based on the recorded time stamp.

16. The computer program product of claim 15, wherein the use of the first random token with the virtual credential for completing the first action is denied based on:
determining that the one or more parameters do not match the set of information received from the entity system; and
determining that the current time stamp for completing the first action using the first random token has not exceeded the predetermined time limit.

17. The computer program product of claim 16, wherein an executable portion configured to send a denial notification to the entity system, wherein the denial notification comprises instructions for the entity system not to finalize the first action.

18. The computer program product of claim 16, wherein an executable portion configured to generate a second random token for completing the first action based on denying the use of the first random token with the virtual credential for completing the first action.

19. The computer program product of claim 18, wherein an executable portion configured to notify the user about the second random token.

20. The computer program product of claim 15, wherein an executable portion configured to send an authorization notification to the entity system, wherein the authorization notification comprises authorization for using the first random token with the virtual credential for completing the first action, wherein the entity system upon receiving the notification finalizes the first action.
